(19) United States
(12) Patent Application Publication
(10) Pub. No.: US 2026/0115846 A1
(43) Pub. Date: Apr. 30, 2026

(54) Device for Machining Wheel Sets for Rail Vehicles

(71) Applicant: Hegenscheidt-MFD GmbH, Erkelenz (DE)

(72) Inventors: Marvin Fischer, Erkelenz (DE); Kay-Erik Finke, Erkelenz (DE)

(21) Appl. No.: 19/150,931

(22) PCT Filed: Jan. 19, 2024
(86) PCT No.: PCT/EP2024/051265

§ 371 Date: Jul. 25, 2025

(30) Foreign Application Priority Data
Jan. 26, 2023 (DE) 10 2023 101 926.0

(51) Int. Cl. B23Q 1/50

(52) U.S. Cl. CPC B23Q 1/50

(57) ABSTRACT

A device for processing wheel sets for rail vehicles is shown and described. The device includes support rollers for rotatably holding a wheel set, wherein at least two of the support rollers are assigned to each of the two wheels of the wheel set, wherein at least one of the support rollers has an actuator for rotating the wheel set and/or wherein at least one actuating roller is provided for rotating the wheel set, guide rollers for axial guidance of the wheel set, wherein at least one guide roller is assigned to each of the two wheels of the wheel set, tools for machining the wheel set, in particular the running surfaces and/or the brake disks of the wheelset, wherein at least one tool is assigned to each of the two wheels of the wheel set, and at least one handling device for receiving and moving a thrust bearing for radially fixing the wheel set, wherein at least one handling device is assigned to each of the two wheels of the wheel set. In order to be able to easily and quickly change and replace the thrust bearings used to fix the wheel sets in their position, it is proposed that the one minimally required handling device must have at least two degrees of freedom of movement, in particular at least three degrees of freedom of movement.

### CROSS-REFERENCE TO RELATED APPLICATIONS

This application is the United States national phase of International Patent Application No. PCT/EP2024/051265 filed Jan. 19, 2024, and claims priority to German Patent Application No. 10 2023 101 926.0 filed Jan. 26, 2023, the disclosures of which are hereby incorporated by reference in their entireties.

### BACKGROUND OF THE INVENTION

### Field of the Invention

The invention relates to a device for machining wheel sets for rail vehicles, comprising: support rollers for rotatably holding a wheel set, wherein at least two of the support rollers are assigned to each of the two wheels of the wheel set, wherein at least one of the support rollers has an actuator for rotating the wheel set and/or wherein at least one actuating roller is provided for rotating the wheel set, guide rollers for axial guiding of the wheel set, wherein at least one guide roller is assigned to each of the two wheels of the wheel set, tools for machining the wheel set, in particular the running surfaces and/or the brake discs of the wheel set, wherein at least one tool is assigned to each of the two wheels of the wheel set, and at least one handling device for receiving and moving a thrust bearing for radially fixing the wheel set, wherein at least one handling device is assigned to each of the two wheels of the wheel set.

Wheel sets for rail vehicles are used to safely carry and guide rail vehicles and are therefore safety-relevant for the reliable movement of rail vehicles. The geometry of the running surfaces of the wheel sets determines the course of the vehicles in interaction with the geometry of the rail. However, due to the rolling contact between the wheel set and the rail, the wheel sets are subjected to heavy stress and the running surfaces are subject to wear. In the maintenance of rail vehicles, the wheel set and its running surface are of particular relevance, as the high requirements for reliability require regular inspection of the running surface geometry.

Various machine tools are known for correcting the tread geometry of wheel sets (‘reprofiling’). Since wheel sets are rotationally symmetrical components, lathes are primarily used for machining them, which are therefore also referred to as wheel set lathes.

For known wheel set lathes, a distinction can be made between mobile wheel set lathes and stationary, i.e. stationary wheel set lathes. The reprofiling of a wheel set is carried out using process steps that differ for mobile and stationary wheel set lathes.

For stationary wheel set lathes, the rail vehicle with the wheel set to be machined is positioned on the wheel set lathe; the wheel set is thus moved relative to the machine. This can be done, for example, by the wheel set lathe being arranged in a workshop pit below a workshop track on which the rail vehicle can be moved in such a way that the wheel set to be machined can be brought into the required position above the wheel set lathe. The wheel set to be machined is then fixed on the wheel set lathe (rotatable) to enable precise machining. The wheel set can then be machined, after which the fixing device of the wheel set can be released again.

### DESCRIPTION OF RELATED ART

Stationary wheel set lathes are known, for example, from DE 1 285 839 A or WO 2006/072584 A1.

On the other hand, for mobile wheel set lathes, the wheel set to be machined or the entire rail vehicle must be lifted, and the wheel set lathe must be positioned below the wheel set to be machined. In contrast to stationary wheel set lathes, the machine must be moved relative to the wheel set in this case. This can be done, for example, by moving the mobile wheel set lathe on a workshop track. The wheel set to be machined is then fixed on the wheel set (rotatable) to enable precise machining. The wheel set can then be machined, after which the fixing device of the wheel set can be released again.

Mobile wheel set machining equipment is known, for example, from European patent EP 1 606 072 B1 and from European patent EP 1 984 134 B1.

For both machine types—i.e. both stationary and mobile wheel set lathes—essential activities therefore consist of fixing or ‘clamping’ as well as the subsequent loosening of wheel sets. These steps are used to set up the wheel set lathe for the machining operation, meaning that they are ‘setup times’. During setup, the wheel set lathe cannot be used productively, which is why setup times must be kept as short as possible.

In both machine types, the wheel set is fixed in place by means of mechanical thrust bearings (sometimes referred to as ‘claws’). In order to rotate the wheel sets during machining and to be able to transfer the torque required for this to the wheel sets, the wheel sets are, for example, mounted on driven friction rollers, which press the wheel sets from below against the mechanical thrust bearings, which engage at the two ends (i.e. on the steering knuckles or shaft knuckles) of the wheel sets and prevent an upward movement of the wheel set in radial direction. Due to the required stiffness and robustness, the thrust bearings must be designed to be very solid, often as a heavy welded construction made of steel.

The thrust bearings must be adapted to the specific rail vehicle type and wheel set to ensure its safe and precise fixing. In addition, the thrust bearings must be removed from the clearance of the rail vehicle after each machining operation to avoid collision with the rail vehicle. Especially on mobile wheel set machining devices, the thrust bearings often need to be completely separated from the machine before the device can be moved to the next wheel set to be machined.

Both the replacement of the thrust bearings and the removal of the thrust bearings from the vehicle have previously been carried out manually, which is time-consuming due to the considerable weight and prolongs the setup times. Manually loading the machine with thrust bearings is also disadvantageous for reasons of work safety and ergonomics due to the frequent repetition of the process and the great mass of the thrust bearings (approx. 20 kg to 30 kg).

In the case of the mobile wheel set machining device, which is known from EP 1 606 072 B1, the thrust bearings are designed as hook-shaped ‘clamps 5’ (see FIG. 1 of EP 1 606 072 B1). These clamps must be moved manually in the axial direction after machining; hence, these clamps must be replaced manually. This results in the disadvantages described above.

In the stationary wheel set machining device, known from DE 1 285 839 A, the thrust bearings are designed as ‘clamps 11’, which can fix a wheel set via its axial bearing housing in the vertical (i.e. radial) direction (cf. FIG. 1 of DE 1 285 839 A). However, on this machine, too, the claws must be changed manually, which also results in the disadvantages described above. Although the claws can be moved mechanically in a vertical (i.e. radial) direction via hydraulic pistons, an axial displacement of the claws must be carried out manually (via an axially movable support beam), since the device carrying the claws can only be adjusted in a vertical direction (via the hydraulic pistons). The radial and axial displaceability of the clamps is also not intended to prevent collisions, but rather to be able to fix and machine wheel sets with internal steering knuckles (cf. FIG. 2 of DE 1 285 839 A).

### SUMMARY OF THE INVENTION

Against this background, the invention is based on the object of designing and further developing a device for machining wheel sets for rail vehicles described at the outset in such a way that the thrust bearings used for fixing the wheel sets can easily and quickly change their position and be replaced.

This object is achieved in the case of a device according to the generic concept as described herein in that the one minimally required handling device has at least two degrees of freedom of movement, in particular at least three degrees of freedom of movement.

The invention relates to a device for machining wheel sets for rail vehicles. Machining may include in particular metal cutting, for example, by turning or by means of a lathe. The device comprises in the first place support rollers for rotatably holding a wheel set, wherein at least two of the support rollers are assigned to each of the two wheels of the wheel set. The support rollers are used to support the wheel set and store it (rotating). At least one of the support rollers may have an actuator for rotating the wheel set. Preferably, however, all support rollers are equipped with an actuator. In this way, the support rollers can transfer drive forces or drive torques to the wheels of the wheel set via friction. As an alternative to driven support rollers, at least one separate actuating roller for rotating the wheel set can be provided. Accordingly, the ‘support/bearing’ and ‘drive’ functions are separated from each other in this case. The device further comprises guide rollers for axial guidance of the wheel set, wherein at least one guide roller is assigned to each of the two wheels of the wheel set. The guide rollers are therefore also referred to as ‘axial guide rollers’. The device further comprises tools for machining the wheel set, in particular the running surfaces and/or the brake discs of the wheel set, wherein at least one tool is assigned to each of the two wheels of the wheel set. In particular, the tools may be lathing tools. Finally, the device comprises at least one handling device for receiving and moving a thrust bearing for radially fixing the wheel set, wherein at least one handling device is assigned to each of the two wheels of the wheel set. The handling device (also called ‘manipulator’ or ‘claw manipulator’) is able to move the thrust bearings (or: ‘claws’), which makes it easier to replace the thrust bearings. It may be provided that the handling device only supports the thrust bearing when changing the thrust bearing and transfers the thrust bearing to an outer bearing fixture for machining (cf. FIGS. 4, 5). Alternatively to this, it may be provided that a separate outer bearing fixture is omitted and that the thrust bearing also remains on the handling device (in this case in a particularly rigid design) during machining (cf. FIGS. 2, 3).

According to the invention, the one minimally required handling device must have at least two degrees of freedom of movement, in particular at least three degrees of freedom of movement. By not only having one degree of freedom of movement (e.g. a vertical adjustability), but two or more degrees of freedom of movement (e.g. horizontal adjustability and/or pivotability or rotatability about a vertical axis of rotation), the handling device can realise various advantages. Firstly, the flexible movement options facilitate the easy replacement of the thrust bearings, as the thrust bearings can be moved to an ergonomically optimal position for the change. Secondly, the flexible range of movements available make it easier to quickly and easily swing the handling device out of the collision area and to swing it back in the direction of the wheel set. In other words, the thrust bearings can be moved between a ‘machining position’ or ‘transfer position’ and a ‘parking position’.

One embodiment of the device envisages that the handling device must have at least one actuator, in particular at least two actuators. The use of actuators, in particular rotary actuators or linear actuators, ensures that the movements of the handling device—as opposed to manual movement—can be carried out even faster and more ergonomically. An actuator for the vertical adjustment of the handling device is particularly advantageous, since the thrust bearings are solid and heavy in design and therefore require considerable effort in lifting them. The handling device may also have two or more actuators, for example, for horizontal adjustability and/or for pivoting or rotation about a vertical axis of rotation.

The device can be further configured by providing the handling device with a first pivot joint on the device for rotatably holding the handling device, in particular for rotating the handling device about a vertical first axis of rotation. The pivot joint allows the handling device and the thrust bearing attached to it to be quickly and easily swung out of the collision area after replacing a thrust bearing and to be swing back in the direction of the wheel set before replacing the next thrust bearing. The pivot joint thus allows easy pivoting between a ‘machining position’ or ‘transfer position’ and a ‘park position’.

A further embodiment of the device provides that the handling device may have a first section with a first linear guide, in particular for linear retraction and extension of the handling device in a horizontal direction. Alternatively or in addition to this, the handling device may have a second section with a second linear guide, in particular for linear raising and lowering of the handling device in a vertical direction. The first section with the first linear guide serves to enable the retraction and extension of the handling device in a horizontal direction, i.e. to change the horizontal distance between the wheel set and the thrust bearing. The second section with the second linear guide, on the other hand, serves to raise and lower the handling device in a vertical direction, which considerably simplifies the replacement of the heavy thrust bearings. The combination of horizontal and vertical movability achieves a high degree of flexibility, which can be used to solve various tasks (e.g. replacement of thrust bearings, switching between ‘machining position’ or ‘transfer position’ and ‘park position’. Preferably, the second section must be angled by 90° with respect to the first section.

A further embodiment of the device provides that the handling device has a receptacle for exchangeably holding a thrust bearing. For this purpose, it may also be provided that the receptacle of the handling device is rotatably mounted, in particular for rotating the thrust bearing about a vertical second axis of rotation. The fixture is used to hold and replace differently shaped thrust bearings so that differently shaped wheel sets can be fixed and machined. Preferably, the receptacle also allows a linear adjustability of the thrust bearing, for example by means of a configuration as a slot nut. The receptacle of the handling device (for example a slot nut) can also be rotatably mounted, which makes it easier, for example, to replace the thrust bearing even in confined spaces.

A further embodiment of the device envisages additional rollers for moving the device on rails. The device can be moved on rails by rolling; in other words, it can be a mobile wheel set machining device, in particular a wheel set lathe. The use of the handling device described above has particular advantages in mobile wheel set machining devices, since both the replacement of the thrust bearings and the collision-free movement in mobile machines are more difficult than in stationary machines, in which the environment can be more easily adapted to the machine, for example by providing aids for replacing the thrust bearings such as cranes.

According to a further embodiment of the device, at least one outer bearing fixture is provided for receiving and moving a thrust bearing for radial fixing of the wheel set, wherein at least one outer bearing fixture is assigned to each of the two wheels of the wheel set. The outer bearing fixture is used to hold a thrust bearing in order to fix the wheel set in place in radial direction during machining. Thanks to a separate outer bearing fixture, the thrust bearing does not have to remain on the handling device during machining but can remain in the hold of the specially designed outer bearing fixture. Although the outer bearing fixture is designed to be less movable than the handling device, it can be designed to be considerably more rigid. The handling device, on the other hand, can be designed to be lighter and more compact. A functional separation is thus made: the outer bearing fixture is used for holding the thrust bearing during machining; the handling device takes over and facilitates the replacement of the thrust bearings.

In relation to this embodiment of the device, it is further proposed that the outer bearing fixture must have a receptacle for exchangeably holding a thrust bearing, wherein the receptacle of the outer bearing fixture is preferably adjustable in a vertical direction. Since, in addition to the handling device, the outer bearing fixture also has a receptacle for a thrust bearing, the thrust bearing can be pushed back and forth between the two receptacles. For this purpose, the two receptacles are preferably arranged at the same height, in close proximity to each other. In this way, the thrust bearing can be pushed from the receptacle of the handling device before machining to the receptacle of the outer bearing fixture, where it remains during machining, and is then (i.e. after machining) pushed back onto the receptacle of the handling device to be replaced. In the meantime (i.e. during machining), the handling device can be swivelled into a ‘park position’. The only manual intervention is therefore to push the thrust bearing back and forth, which represents a considerable simplification compared to a fully manual thrust bearing replacement with manual lifting of the thrust bearing.

The invention will be explained in more detail below with reference to a drawing which represents only one preferred exemplary embodiment. The drawing shows in:

### BRIEF DESCRIPTION OF THE DRAWINGS

The terms Fig., Figs., Figure, and Figures are used interchangeably in the specification to refer to the corresponding figures in the drawings.

FIG. 1: a handling device as the device according to the invention in perspective,

FIG. 2: a first embodiment of a device according to the invention with the handling device from FIG. 1 in a frontal view;

FIG. 3: the device according to the invention from FIG. 2 in a side view,

FIG. 4: a second embodiment of a device according to the invention with a handling device from FIG. 1 in frontal view, and

FIG. 5: the device according to the invention from FIG. 4 in a side view.

### DESCRIPTION OF THE INVENTION

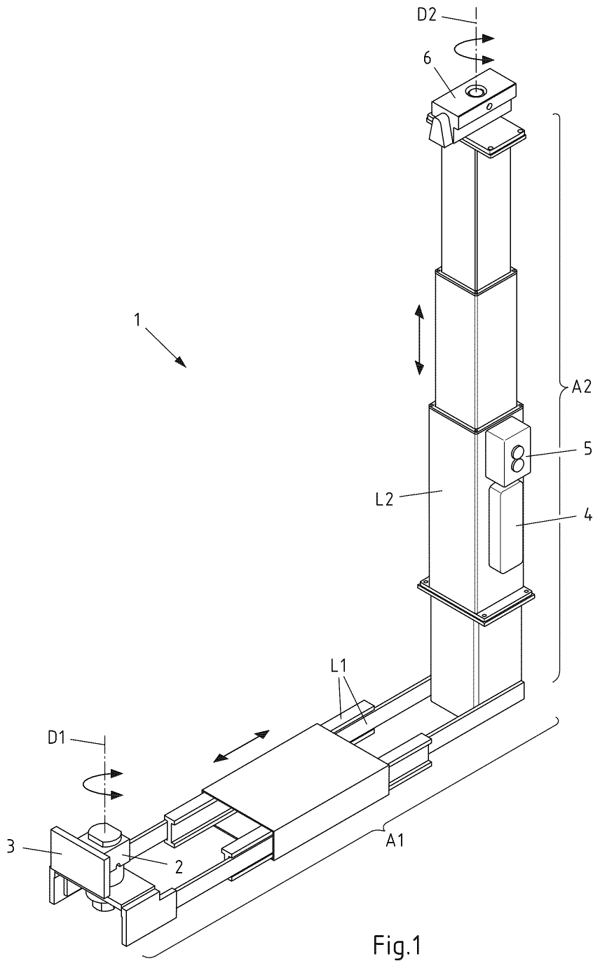

FIG. 1 shows the handling device 1 as the device according to the invention (not illustrated in FIG. 1) in perspective. Handling device 1 has several degrees of freedom of movement, which are explained below. A first degree of freedom of movement is due to the fact that the handling device 1 can be rotated about a vertical first axis of rotation D1 (indicated in FIG. 1 by a double arrow). For this purpose, the handling device 1 has a pivot joint 2. Handling device 1 has an adapter plate 3 adjacent to the pivot joint 2, by means of which the handling device 1 can be attached to the device (not illustrated in FIG. 1).

Handling device 1 also has a first section A1 with a first linear guide L1. The first section A1 is arranged on a horizontal plane and serves to extend and retract the handling device 1 linearly in a horizontal direction (indicated in FIG. 1 by a double arrow). In the case of the embodiment illustrated in FIG. 1 and preferred in this respect, the first linear guideway L1 features two extractable rails. The (horizontal) stroke of the first linear guideway L1 is preferably at least 400 mm, in particular at least 500 mm. The handling device 1 also has a second section A2 with a second linear guide L2. The second section A2 extends in a vertical direction and serves to linearly raise the handling device 1 in a vertical direction and to lower it again (indicated in FIG. 1 by a double arrow). In the embodiment shown in FIG. 1 and preferred in this respect, the second linear guideway L2 features a multi-part telescopic-type linear lifting column. The (vertical) lift of the second linear guide L2 is preferably at least 500 mm, in particular at least 600 mm. The second linear guide L2 is equipped with an actuator 4, which can be operated via a pushbutton 5.

Handling device 1 also has a receptacle 6 for exchangeably holding a thrust bearing (not shown in FIG. 1). The receptacle 6 of the handling device 1 is rotatably mounted such that the receptacle 6 (possibly with a thrust bearing 10) can rotate about a vertical second axis of rotation D2 (indicated in FIG. 1 by a double arrow).

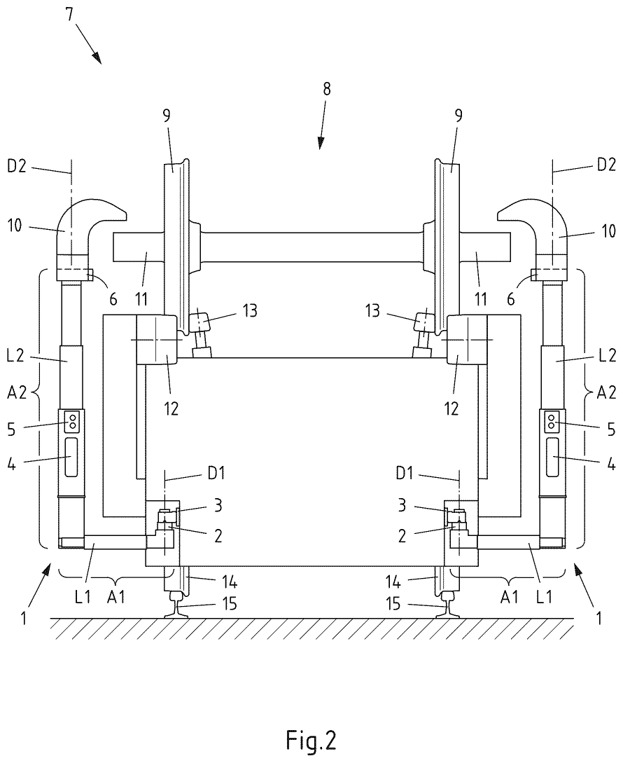

FIG. 2 shows a first embodiment of a device 7 according to the invention with the handling device 1 from FIG. 1 in frontal view. The reference marks already used in connection with FIG. 1 are used accordingly in FIG. 2. It is apparent that the device 7 carries a wheel set 8 with two wheels 9 and is equipped with two handling devices 1, with a handling device 1 being assigned to each of the two wheels 9. Furthermore, FIG. 2 illustrates that both handling devices 1 are equipped with a thrust bearing 10 (also referred to as ‘claw’). Wheel set 8 has two ends 11 (also referred to as ‘steering knuckle’ or ‘shaft knuckle’), designed to engage the thrust bearings 10 during machining to prevent a movement of the wheel set 8 in an upward radial direction.

Device 7 shown in FIG. 2 serves to machine wheel sets 8 for rail vehicles and comprises four support rollers 12 for rotatably holding the wheel set 8, wherein two of the support rollers 12 are assigned to each of the two wheels 9 of the wheel set 8. The support rollers 12 each have an actuator in order to be able to drive, i.e. rotate, the wheel set 8 mounted on the support rollers 12 during machining. Device 7 also has guide rollers 13 for axial guidance of the wheel set 8, wherein a guide roller 13 is assigned to each of the two wheels 9 of the wheel set 8. Device 7 further comprises tools (concealed in FIG. 2 behind the support rollers 12) for machining the wheel set 8, in particular for machining the running surfaces and/or the brake discs of the wheel set 8. At least one tool is assigned to each of the two wheels 9 of the wheel set 8. Device 7 also has rollers 14 for displacing the device 7 on rails 15.

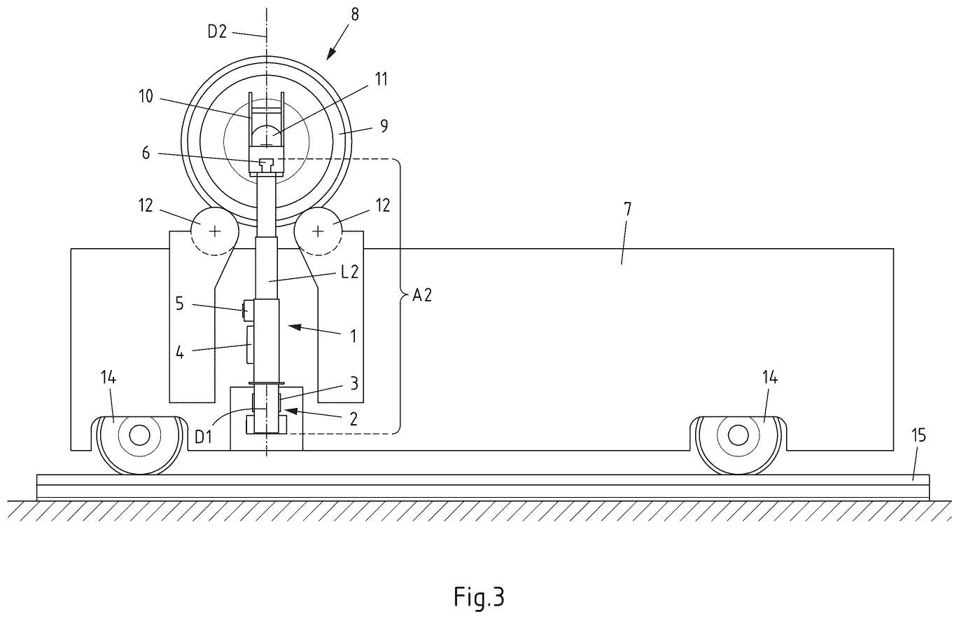

FIG. 3 shows the device 7′ according to the invention from FIG. 2 in a side view. The reference marks already used in connection with FIG. 1 and FIG. 2 are used accordingly in FIG. 3. In the side view, the (rotating) hold of the wheel set 8 on the support rollers 12 is clearly visible. In addition, the rail 15, on which the device 7 can be moved on its rollers 14 is easily recognisable.

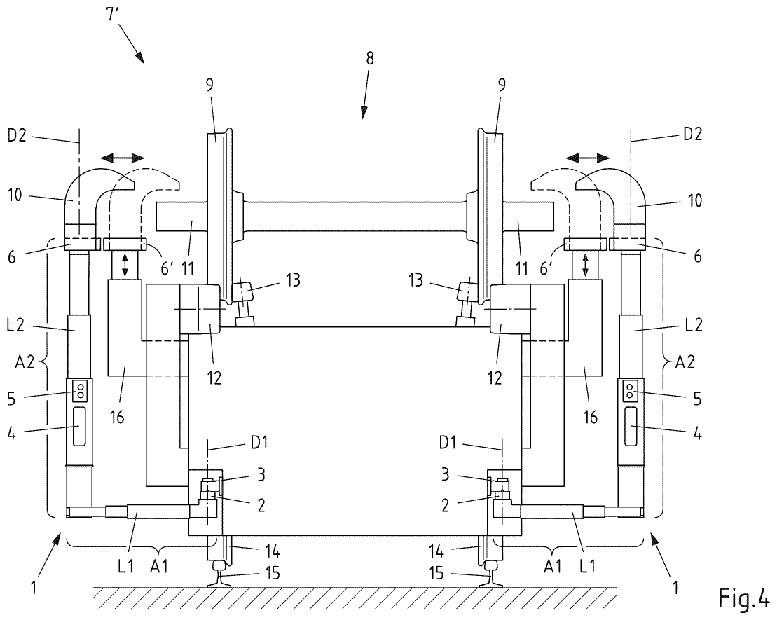

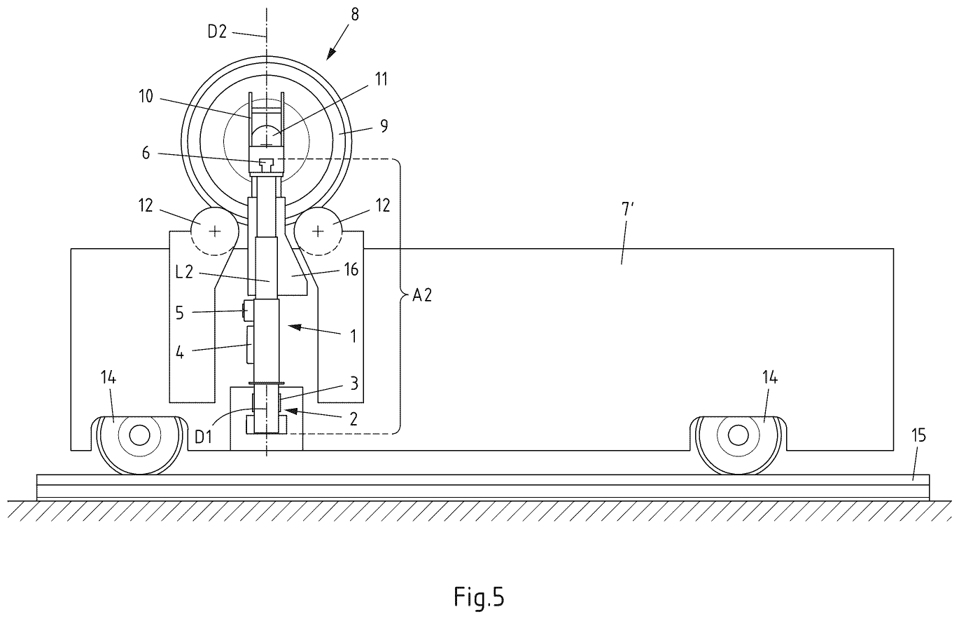

FIG. 4 shows a second embodiment of a device 7′ according to the invention with a handling device 1 from FIG. 1 in frontal view. FIG. 5 finally shows the device according to the invention from FIG. 4 in side view. The reference marks already used in connection with FIG. 1 to FIG. 3 are used accordingly in FIG. 4 and FIG. 5. The second (in FIG. 4 and FIG. 5 shown) embodiment of the device 7′ differs from the first (in FIG. 2 and FIG. 3 shown) embodiment of the device 7 in particular in that the second embodiment of the device 7′ has two outer bearing fixtures 16. The outer bearing fixtures 16 serve to accommodate a thrust bearing 10 in each case in order to fix the wheel set 8 in place in radial direction during machining. The outer bearing fixtures 16 each have a receptacle 6′ for exchangeably holding a thrust bearing 10, wherein the receptacle 6′ is preferably adjustable in a vertical direction. In this way, the thrust bearing 10 can be pushed from the receptacle 6 of the handling device 1 before machining onto the receptacle 6′ of the outer bearing fixture 16, where it remains during machining, and is then pushed back onto the receptacle 6 of the handling device 1 to be replaced (indicated in FIG. 4 by double arrows and hatched thrust bearing 10).

### LIST OF REFERENCE NUMERALS

1: Handling device
2: First pivot joint
3: Adapter plate
4: Actuator (of the second linear guideway L2)
5: Pushbutton
6: Receptacle (of the handling device 1 for the thrust bearing 10)
6′: Receptacle (of the outer bearing fixture 16 for the thrust bearing 10)
7,7: Device
8: Wheel set
9: Wheel
10: Thrust bearing
11: Ends (of wheel set 8)
12: Support roller
13: Guide roller
14: Roller
15: Rail
16: Outer bearing fixture
A1: first section
A2: second section
D1: first axis of rotation (vertical)
D2: second axis of rotation (vertical)
L1: first linear guide
L2: second linear guide

1-10. (canceled)

11. A device for machining wheel sets for rail vehicles, comprising:
support rollers for rotatably holding a wheel set, wherein at least two of the support rollers are assigned to each of the two wheels of the wheel set,
wherein at least one of the support rollers has an actuator for rotating the wheel set and/or wherein at least one drive roller is provided for rotating the wheel set,
tools for machining the wheel set, in particular the running surfaces and/or the brake disks of the wheel set, wherein at least one tool is assigned to each of the two wheels of the wheel set, and
at least one outer bearing fixture for receiving and moving a thrust bearing for radial fixing of the wheel set, wherein at least one outer bearing fixture is assigned to each of the two wheels of the wheel set
characterised by
guide rollers for axial guidance of the wheel set, wherein at least one guide roller is assigned to each of the two wheels of the wheel set,
at least one from the outer bearing fixture separate handling device for receiving and moving a thrust bearing for radially fixing the wheel set, wherein at least one handling device is assigned to each of the two wheels of the wheel set,
the one minimally required handling device must have at least two degrees of freedom of movement, in particular at least three degrees of freedom of movement.

12. The device according to claim 11,
wherein
the handling device has at least one actuator, in particular at least two actuators.

13. The device according to claim 11,
wherein
the handling device has a first pivot joint for rotatably holding the handling device on the device, in particular for rotating the handling device about a vertical first axis of rotation.

14. The device according to claim 11,
wherein
the handling device has a first section with a first linear guide, in particular for linear retraction and extension of the handling device in a horizontal direction.

15. The device according to claim 11,
wherein
the handling device has a second section with a second linear guide, in particular for linearly raising and lowering the handling device in a vertical direction.

16. The device according to claim 11,
wherein
the handling device has a receptacle for exchangeably holding a thrust bearing.

17. The device according to claim 16,
wherein
the receptacle of the handling device is rotatably mounted, in particular for rotation of the thrust bearing about a vertical second axis of rotation.

18. The device according to claim 11,
characterised by
rollers for moving the device on rails.

19. The device according to claim 18,
wherein
the outer bearing fixture has a receptacle for exchangeably holding a thrust bearing, wherein the receptacle of the outer bearing fixture is preferably adjustable in a vertical direction.
